(19) United States
(12) Patent Application Publication
(10) Pub. No.: US 2025/0182055 A1
(43) Pub. Date: Jun. 5, 2025

(54) SYSTEM AND METHOD FOR GENERATING A GLOSSARY OF BUSINESS METRICS FOR SELF-SERVICE ANALYTICS METADATA

(71) Applicants: Ryan Goodman, Davie, FL (US); Anton Kudriavtsev, Davie, FL (US)

(72) Inventors: Ryan Goodman, Davie, FL (US); Anton Kudriavtsev, Davie, FL (US)

(21) Appl. No.: 19/008,606

(22) Filed: Jan. 2, 2025

(51) Int. Cl. G06Q 10/10; G06Q 10/067

(52) U.S. Cl. CPC G06Q 10/103; G06Q 10/067

(57) ABSTRACT

A system for generating a glossary of business metrics is disclosed, including a reverse-engineering methodology to analyze the frequency and adoption of a plurality of self-service reports to permit the system to infer business correctness and to permit the generation of a business glossary via at least one self-service dashboard.

### TECHNICAL FIELD

The embodiments disclosed herein generally relate to systems for generating a business metrics glossary.

### BACKGROUND

In complex business environments, data is transformed into business metrics to form the foundation for decision-making. However, the decentralized nature of data systems and workflows creates significant challenges in maintaining consistency and accuracy in metric definitions. Knowledge resides with subject matter experts who understand the nuances of their domains, but these insights are not effectively shared across teams. Context for metrics is embedded in metadata and business logic, often locked within dashboards or analytics systems, making it difficult to adapt or reuse consistently. Actionable decisions are decentralized, with teams independently creating metrics based on their immediate priorities, leading to duplication, misalignment, and inefficiencies.

These challenges are compounded by the inherent variability of metric definitions. In some cases, variability is purposeful, as teams tailor metrics to their specific needs. In other cases, it is accidental, resulting from ambiguous requirements or miscommunication. Additionally, as metrics evolve with changing business priorities, their definitions and implementations often fail to keep pace, creating a disconnect between business intent and technical reality.

Traditional tools, such as static business glossaries or rule-based systems, lack the scalability and adaptability needed to address these issues. They fail to reconcile discrepancies across platforms, align diverse teams, or retain the fluidity of evolving metrics. To address these gaps, this invention introduces a dynamic, AI-driven system for generating and governing business glossaries. By leveraging metadata analysis and centralized knowledge retention, the system ensures consistency, adaptability, and alignment across decentralized workflows.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to a system and method for deriving a business glossary of metrics that ensures accuracy, adaptability, and alignment across decentralized analytics environments. The system balances centralized governance with decentralized implementation, enabling flexibility while ensuring consistency. The system is designed to scale for enterprise use and integrate seamlessly with platforms like Salesforce, Tableau, or SAP. In embodiments, user feedback (e.g., manual validation or conflict resolution) is incorporated into the glossary to enhance accuracy over time.

The embodiments provided herein relate to a system for generating a glossary of business metrics. The system includes a reverse-engineering methodology to analyze the frequency and adoption of a plurality of self-service reports, dashboards, and visualizations to permit the system to infer business correctness and to permit the generation of a business glossary via at least one self-service dashboard. A method for generating a glossary of business metrics for self-service analytics metadata is also provided. A dashboard enables a user to scan and identify the most utilized dashboard(s) and reports within a business application, inferring their correctness based on adoption and usage. A metadata extraction process scrapes the detailed metadata from these dashboards and reports within a business application. As used herein, “business correctness” and variations of that phrase refers to alignment with real-world relevance, validation through frequent use, and organizational trust. Inferred business correctness may be determined by analyzing usage patterns and metadata characteristics, such as filter logic and aggregation hierarchies, to assess metric relevance and consistency.

In one aspect, a distinct reverse-engineering approach is employed. Metadata extraction captures detailed information from dashboards and reports, including filters, dimensions, aggregations, and underlying data sources, to infer metric definitions and semantics. Contrary to prevalent processes that initiate with human requirements and definitions gathering to make up a business glossary and subsequently research data and metadata. The embodiments disclosed uniquely prioritize the frequency of use and adoption from “self-service” created and validated reports to infer business correctness to derive a business glossary. By doing so, the system infers business correctness, effectively deriving a business glossary from real-world application and relevance.

In one aspect, the system uses inferred correctness based on utilization to associate frequency, and the adopted use of self-service dashboards as an indication of its accuracy and relevance is an innovative approach. In embodiments, the system calculates inferred correctness by associating frequency of use and adoption patterns with business relevance, creating a self-validating mechanism for metric accuracy. This shifts the paradigm from human-reliant validation to data-driven inference. Traditional methods rely on SMEs and manual validation processes.

In one aspect, the system utilizes metadata extraction as a primary source for metrics and semantics definitions. The emphasis on metadata and its rich detail to derive metrics is not utilized in the prior art. The assumption that a report's metadata encapsulates the business glossary concepts is advantageous. Especially the focus on treating report filters to infer metric measurements.

In one aspect, the system employs an AI-assisted reasoning engine, which may include large language models (LLMs), for tasks such as deduplication, categorization, and contextual interpretation of metrics, ensuring semantic alignment across the generated business glossary, making it different from traditional manual or rule-based approaches.

In one aspect, the ability to continuously monitor and track changes in metrics ensures the glossary remains up-to-date, effectively allowing changes to dashboards and reports to continuously drive updates to the metrics glossary. This dynamic update feature is unique when tied directly to the inferred glossary.

In one aspect, the support for multiple aliases and terms for a single metric is a beneficial feature, ensuring adaptability across different business units, geographies, or linguistic preferences including logical implementations across business and analytical applications. By supporting multiple aliases and terms, and logical definitions a single metric, the system allows organizations to tailor glossary entries to diverse business units, geographic regions, linguistic preferences, and business and analytics applications. while maintaining consistency in underlying definitions

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a system architecture diagram of the network infrastructure, according to some embodiments;

FIG. 2 illustrates a system architecture diagram of the network infrastructure, according to some embodiments;

FIG. 3 illustrates a flowchart of a method for generating a glossary of business metrics for self-service analytics metadata;

FIG. 4 illustrates a flowchart of a method for generating a glossary of business metrics for self-service analytics metadata;

FIG. 5 illustrates a flowchart of a method for generating a glossary of business metrics for self-service analytics metadata; and

FIG. 6 illustrates a flowchart of a system for generating a glossary of business metrics for self-service analytics metadata.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the system and method may analyze user and system lexicology in business or analytics applications to reverse-engineer frequently accessed reports, extracting metadata, taxonomies, and semantics to create a standardized business glossary with key metrics, simplifying the creation and upkeep of a consistent metric dictionary and business semantics for organizations. Key metrics and metadata elements such as filters, aggregation formulas, and hierarchical relationships are analyzed to extract metric definitions and contextual details, forming the foundation for the glossary. The present invention employs a “reverse-engineering” methodology that analyzes the frequency and adoption of “self-service” reports, allowing the system to infer business correctness and generate a business glossary. This reversal of the usual process streamlines and modernizes glossary creation the crafting and maintenance of a coherent metric dictionary for human and systemic consumption.

One of the innovative aspects of the embodiments is the reliance on utilization patterns as a measure of correctness and relevance. Traditional approaches rely on subject matter experts (SMEs) and manual validation processes, while this method leverages real-world usage data from self-service dashboards.

Aspects of the present invention provide for the dynamic determination of metric importance based on tangible adoption and utilization patterns. Recognizing that metrics from frequently accessed or endorsed dashboards likely hold more business significance, the invention harnesses direct usage statistics or user input. By doing so, it filters out noise, focusing on what truly matters to the organization. Unlike conventional methodologies, which might overlook real-world utilization cues, this method prioritizes and underscores metrics that resonate with genuine use, thereby ensuring alignment with actual business relevance.

The present invention also places an emphasis on metadata extraction to derive metrics. The present invention assumes that a report's metadata contains essential business glossary concepts, and it even considers report filters as sources for inferring metrics. This approach harnesses the richness of metadata for glossary creation.

A fundamental aspect of the invention's methodology is its intensive focus on metadata extraction. Understanding the value of metadata, the invention systematically processes the details of reports to extract key information. It operates on the assumption that a report's metadata contains crucial elements for the business glossary. Moreover, it extends its analysis to components like report filters, treating them as significant sources for inferring metric definitions and semantics. This methodical extraction and interpretation of metadata ensure a comprehensive foundation for the glossary creation.

Furthermore, the use of an AI-assisted reasoning engine for deduplication and contextual interpretation represents a modern, AI-assisted validation layer, distinguishing this method from traditional manual or rule-based approaches. By utilizing an AI-assisted reasoning engine, the invention identifies and resolves potential metric redundancies, ensuring that the derived glossary is both precise and concise. This application of an AI-assisted reasoning engine offers a significant advantage over traditional methods which might rely on manual processes or simplistic rule-based approaches. The system's capability to interpret and understand variations in metric naming or description using these models sets it apart in its accuracy and efficiency.

The embodiments employ a continuous monitoring and change management system that adds significant value by ensuring the glossary remains up-to-date. The dynamic update feature, possibly linked directly to the inferred glossary, is unique. The present invention utilizes a system's support for multiple aliases and multi-lingual terms to enhance adaptability across different business units and linguistic contexts. This contributes to speed, with the process requiring significantly less time and fewer professionals compared to the typical human-in-the-loop approach, which can take several days. This streamlined, data-driven, and automated method holds great promise for efficient glossary creation and maintenance of validity for human and system consumption over time.

Implementations of the invention involve the technical field of text analysis and generation including analyzing the frequency and adoption of a plurality of self-service reports within a business via text analysis, AI-assisted reasoning engine, optical character recognition (OCR), crawling, or similar technique; generating a business glossary via at least one self-service dashboard based on the analyzing; and inferring the business correctness of the business glossary comprising metrics, and are therefore necessarily rooted in computer technology. For example, the steps of analyzing the frequency and adoption of a plurality of self-service reports within a business via text analysis, AI-assisted reasoning engine, OCR, crawling, or similar techniques and inferring the business correctness of the business glossary comprising metrics such as via AI-assisted reasoning engine are computer-based and cannot be performed in the human mind. The present invention amounts to more than merely implementing the generic computer as a tool to gather, analyze, and output data because the steps of the present method, system, or product improve the functioning of business glossary generation, monitoring, and updating, by reducing the computing hardware and time required to accomplish the same. Additionally, the steps of the present invention would be impossible to accomplish on pen and paper due to the volume of data being communicated and received over a network in real-time. In particular, the speed at which the steps of the present invention occur to effectuate the disclosed method, system, or product would involve large-scale, continuous wireless communication of such data. That is, the steps of the present method, system, or product are impossible to accomplish on pen and paper, cannot be accomplished as a method of organizing human activity, and amount to significantly more than merely gathering, analyzing, and outputting data.

Implementations of the present invention include implementing (executing, running, or deploying) one or more AI-assisted reasoning engines on a computing device wherein the computing device executes the AI-assisted reasoning engine's algorithms and mathematical functions on computer hardware using machine learning libraries. The computing device implements the AI-assisted reasoning engine when it performs tasks like training, making predictions, applying the model to data, decision-making, classification, or generating outputs based on inputs. In particular, the speed at which an AI-assisted reasoning engine analyzes and transforms data to effectuate the disclosed method, system, or product would involve large-scale, continuous transformation of such data. As such, the present invention would be impossible to accomplish on pen and paper or in the human mind due to the volume of data being analyzed and transformed by the AI-assisted reasoning engine.

The system may include a dashboard that enables a user to scan and identify the most utilized dashboard(s) and reports within a business application, inferring their correctness based on adoption and usage. A metadata extraction process scrapes the detailed metadata from these dashboards and reports within a business application.

In some embodiments, a metric interference from the metadata is made to analyze the extracted metadata to identify and deduce what measurements are being aggregated. Assumptions include report filters that serve as surrogate metric definitions and formulas, fields, and object names help differentiate similar named metrics. Commonality in metrics across reports indicates their accuracy. Data model construction constructs a consolidated data model using the relationships in the metadata. This model: Links dashboards with their constituent widgets. Connects reports to their underlying data sources and formulas. Consolidation of measurement/metric definitions (fields, report formulas, report filter/record count based metric).

An AI-assisted reasoning engine process utilizes this technology method to process and provide human-like reasoning against metrics and terms through a linguistic model to: Identify potential duplicates or near-duplicates, classify and group metrics by topic.

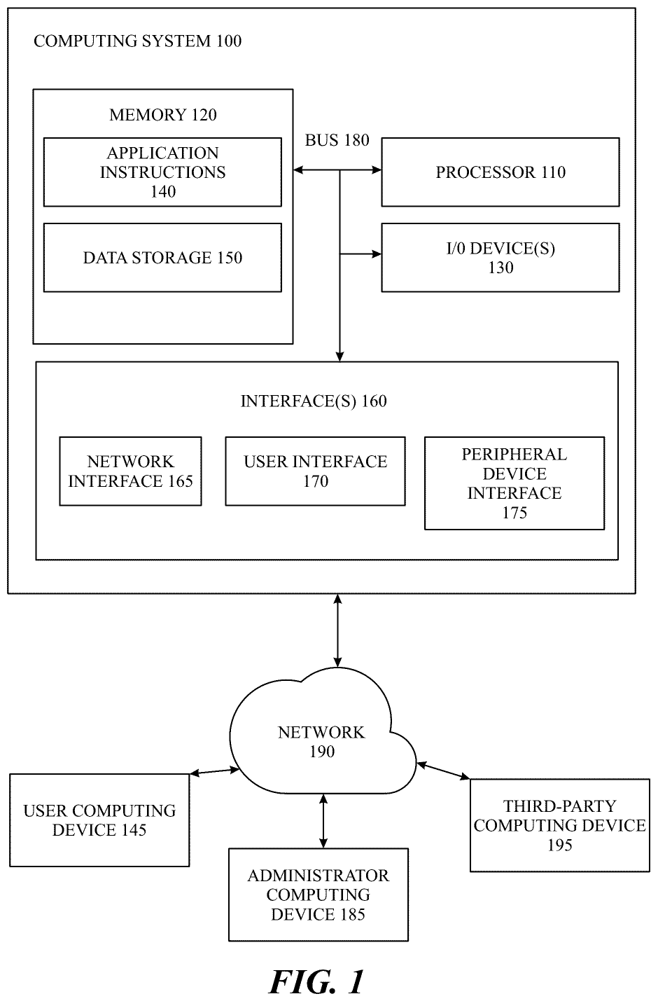

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computer system 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 140, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized by a user to interact with the various functionalities of the system. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

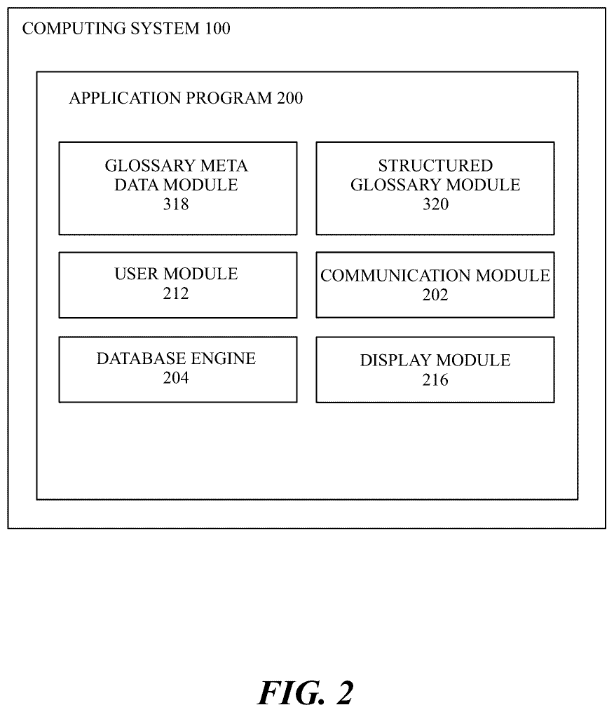

FIG. 2 illustrates an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a glossary metadata module 318, a structured glossary module 320, a communication module 202, a database engine 204, a user module 212, and a display module 216.

In some embodiments, the glossary metadata module 318 is configured to generate a metadata model relating to a metrics glossary by retrieving dashboard metadata, looping report metadata, processing a metadata model, and returning a response. Dashboard metadata may be retrieved, for example, from the database engine 204 or similar data repository.

In some embodiments, the structured glossary module 320 is configured to utilize, or may include, an AI-assisted reasoning engine for deduplication and contextual interpretation to identify and resolve potential metric redundancies, ensuring that the derived glossary is both precise and concise. This application of an AI-assisted reasoning engine offers a significant advantage over traditional methods which might rely on manual processes or simplistic rule-based approaches. The system's capability to interpret and understand variations in metric naming or description using these models sets it apart in its accuracy and efficiency.

In some embodiments, the communication module 202 is configured for receiving, processing, and transmitting a user command and/or one or more data streams. In such embodiments, the communication module 202 performs communication functions between various devices, including the user computing device 145 of FIG. 1, the administrator computing device 185 of FIG. 1, and a third-party computing device 195 of FIG. 1. In some embodiments, the communication module 202 is configured to allow one or more users of the system, including a third-party, to communicate with one another. In some embodiments, the communications module 202 is configured to maintain one or more communication sessions with one or more servers, the administrative computing device 185 of FIG. 1, and/or one or more third-party computing device(s) 195 of FIG. 1. In some embodiments, the communication module 202 may allow users and administrators to communicate with one another.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

The user module 212 may store user preferences including the user account information, historical usage data, user personal information, and the like. The user module 212 may facilitate the creation of user's profiles for users, administrators, and others.

In some embodiments, the display module 216 is configured to display one or more graphic user interfaces, including, e.g., one or more user interfaces. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored. The display module 216 displays information, notifications, and alerts to the user device which can be viewed and acknowledged by the user.

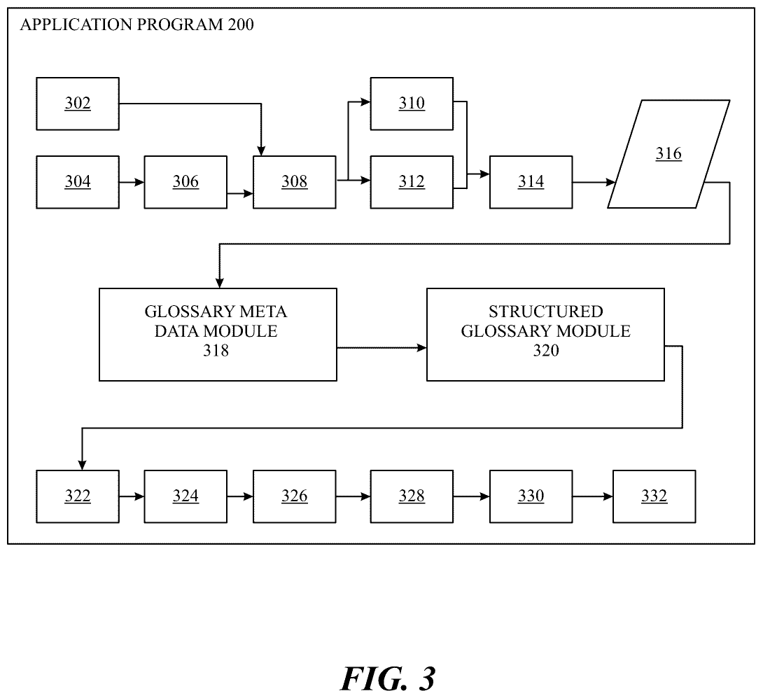

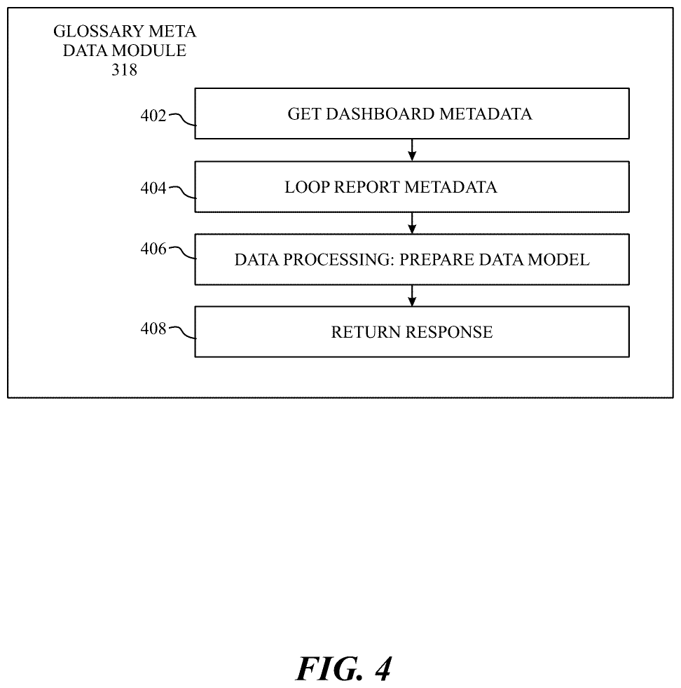

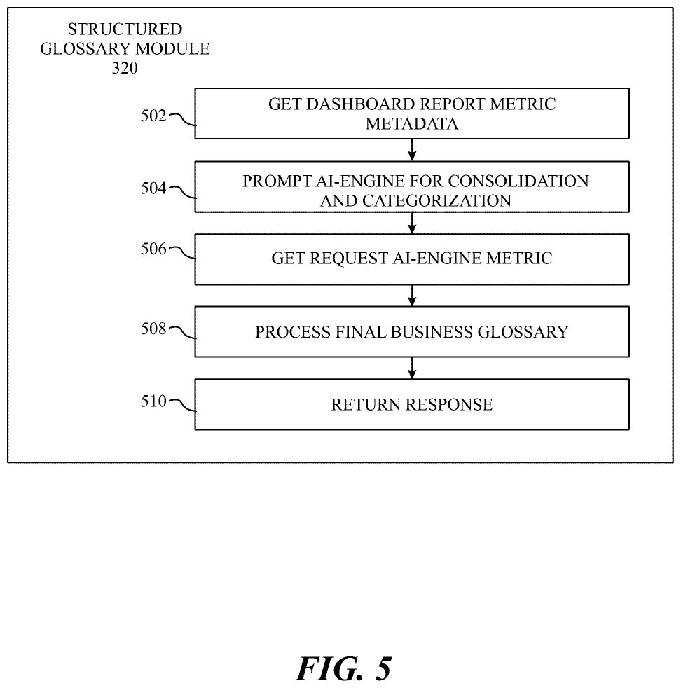

FIG. 3 illustrates a method for implementing the application program 200 of FIG. 2, including a user-initiated 302 or system-initiated 304 metric glossary generation. If the system initiates 204 the metric glossary generation, the system may retrieve the last generated version 306 of the metrics glossary, such as from the database engine 204 of FIG. 2 or similar data repository. In step 308, the system may retrieve a list on analytics assets 308 and retrieve asset usage data 310 and receive user input regarding the most important metrics 312 to be viewed in a dashboard. In step 314, the system may derive assets based on priority analytics and, in step 316, generate a metrics glossary to be input into a metadata model generated via the glossary metadata module 318, depicted as 318 in FIG. 2. The glossary metadata module 318 may be configured to generate a metadata model relating to the received metrics glossary of step 316, and which is discussed in further detail with respect to FIG. 4. The generated metadata model may be communicated to the structured glossary module 320, which may be configured to generate a final business glossary, and which is discussed in further detail with respect to FIG. 5. In step 322, the system may write the final business glossary to structured query language (SQL) and, in step 324, instruct a computing device to display the business glossary. In step 326, human input may, optionally, allow for correction, changes, or approval of the generated business glossary. In step 328, human input may, optionally, allow for commitment to the version of the generated business glossary. In step 330, the system may relate the business metrics glossary to analytics assets and, in step 332, export the business metrics glossary to a language of choice, such as, but not limited to, SQL, python, CSV, etc.

FIG. 4 depicts the glossary metadata module 318 of FIG. 2, which is configured to generate a metadata model relating to a metrics glossary by retrieving dashboard metadata (get dashboard metadata 402), looping report metadata (loop report meta data 404), processing a metadata model (data processing: prepare data model 406), and returning a response (return response 408). That is, in step 402, from a glossary metadata module 318 from which a dashboard was constructed, the system extracts metadata via an API via query and extraction via an integrated metadata extraction module. In step 404, the glossary metadata module 318 parses metadata by analyzing associated reports or queries to understand their structure, logic, and constraints via an embedded report parser service. In step 406, the system processes parsed metadata into a standardized data model representing each metric's attributes via a data modeling engine. In step 408, the system prepares processed data for intermediate validation, caching, or debugging purpose via the glossary metadata module 318. Dashboard metadata may be retrieved, for example, from the database engine 204 or similar data repository.

FIG. 5 depicts the structured glossary module 320 of FIG. 2, which is configured to utilize, or may include, an AI-assisted reasoning engine for deduplication and contextual interpretation to identify and resolve potential metric redundancies, ensuring that the derived glossary is both precise and concise. The structured glossary module 320 may be configured to received metric metadata from the glossary metadata module 318 (get dashboard report metric metadata 502), query a system-integrated AI-assisted reasoning engine to analyze the metric metadata (prompt AI-assisted reasoning engine for consolidation and categorization 504), receive the generated AI-assisted reasoning engine analysis (get request AI-assisted reasoning engine metric 506), generate a final business metric glossary (process final business glossary 508), and return response 510. That is, in step 502, the system accesses the structured data model generated in the preceding steps of FIG. 4. In step 504, the system uses an AI-based reasoning engine to evaluate metrics, detect duplicates, and validate metrics against the existing glossary by parsing metric attributes and comparing them to existing glossary entries, and then outputs a list of flagged metrics with recommendations for user review. In step 506, the structured glossary module 320 receives the list of flagged metrics and parsed metric attributes. In step 508, the structured glossary module 320 consolidates all evaluated metrics into a refined glossary, including consolidated metrics, recommendations for duplicates, conflicts, or aliases, metadata flags for unresolved conflicts, etc. The refined glossary may include a structured output model that captures metadata for each metric including relationships between metrics and recommendations for further actions based on the metadata via a glossary consolidation engine utilized by the consolidates all evaluated metrics into a refined glossary. In step 510, the refined glossary (the final business glossary) is returned to the system for review or integration into business use or systems via an output service of the system. The refined glossary may include metadata about unresolved conflicts or flagged metrics.

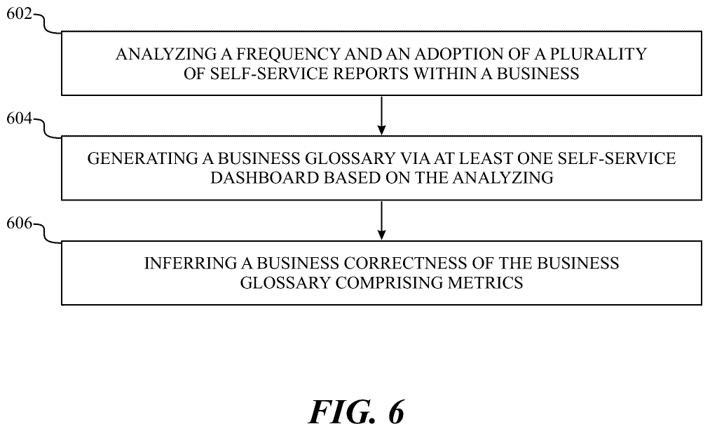

FIG. 6 illustrates a flowchart of a system for generating a glossary of business metrics, the system including, in step 602, analyzing a frequency and an adoption of a plurality of self-service reports within a business via the glossary metadata module 318 of FIG. 2. The system may include, in step 604, generating a business glossary via at least one self-service dashboard based on the analyzing via the glossary metadata module 318 of FIG. 2, and, in step 606, inferring a business correctness of the business glossary comprising metrics via the structured glossary module 320 of FIG. 2.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrases “computing device” or “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

What is claimed is:

1. A system for generating a glossary of business metrics, the system comprising:
at least one computing device in operable communication with a network;
an application server in operable communication with the at least one computing device over the network, the application server configured to host an application program configured to:
analyzing a frequency and an adoption of a plurality of self-service reports within a business;
generating a business glossary via at least one self-service dashboard based on the analyzing; and
inferring a business correctness of the business glossary comprising metrics.

2. The system of claim 1, further comprising:
processing one or more self-service reports, dashboards, and visualizations to identify numeric measurements, contextual filters, and associated business logic via a metadata extraction module.

3. The system of claim 1, further comprising:
analyzing one or more metadata filters, report hierarchies, and relationships between reports and constituent metrics via an inference engine.

4. The system of claim 1, further comprising:
utilizing usage frequency and adoption patterns as proxies for metric correctness; and
integrating business logic extracted from metadata to validate semantic relationships between metrics.

5. The system of claim 1, further comprising a semantic enrichment engine configured to:
deduplicate overlapping metrics,
categorize metrics based on contextual relationships; and
generate aliases and synonyms for metrics to enhance usability and interpretation.

6. The system of claim 1, further comprising:
continuously updating a repository of business performance metrics based on changes in the metadata and report usage, wherein the repository is exposed as an application programming interface for integration with business intelligence tools and automated decision-making platforms.

7. The system of claim 1, further comprising implementing an artificial intelligence model to perform deduplication, categorization, classification, and contextual interpretation of the business glossary.

8. The system of claim 1, further comprising continuously tracking and logging changes to the business glossary over time.

9. The system of claim 1, further comprising implementing machine learning models to deduplicate metrics, infer relationships, and enrich semantic context.

10. The system of claim 1, wherein the business glossary is configured to:
encode metrics for machine-readability to support integration with AI systems; and
provide human-readable definitions for enhanced stakeholder collaboration.

11. A method for reverse-engineering business performance metrics, the method comprising:
analyzing, via a computing device, metadata from a plurality of self-service reports to extract numeric measurements and associated business logic;
inferring, via the computing device, key performance metrics by analyzing report usage patterns, adoption rates, and metadata filters;
validating, via the computing device, inferred metrics by comparing usage data and metadata characteristics to historical trends; and
dynamically generating, via the computing device, a metrics glossary comprising human-readable definitions and machine-readable encodings.

12. The method of claim 11, further comprising:
processing one or more self-service reports, dashboards, and visualizations to identify numeric measurements, contextual filters, and associated business logic via a metadata extraction module.

13. The method of claim 11, further comprising:
analyzing one or more metadata filters, report hierarchies, and relationships between reports and constituent metrics via an inference engine.

14. The method of claim 11, further comprising:
utilizing usage frequency and adoption patterns as proxies for metric correctness; and
integrating business logic extracted from metadata to validate semantic relationships between metrics.

15. The method of claim 11, further comprising a semantic enrichment engine configured to:
deduplicate overlapping metrics, categorize metrics based on contextual relationships; and
generate aliases and synonyms for metrics to enhance usability and interpretation.

16. The method of claim 11, further comprising:
continuously updating a repository of business performance metrics based on changes in the metadata and report usage, wherein the repository is exposed as an application programming interface for integration with business intelligence tools and automated decision-making platforms.

17. The method of claim 11, further comprising implementing an artificial intelligence model to perform deduplication, categorization, classification, and contextual interpretation of the business glossary.

18. The method of claim 11, further comprising continuously tracking and logging changes to the business glossary over time.

19. The method of claim 11, further comprising implementing machine learning models to deduplicate metrics, infer relationships, and enrich semantic context.

20. The method of claim 11, wherein the business glossary is configured to:
Encode metrics for machine-readability to support integration with AI systems; and
provide human-readable definitions for enhanced stakeholder collaboration.
